(19) United States
(12) Patent Application Publication
(10) Pub. No.: US 2025/0009040 A1
(43) Pub. Date: Jan. 9, 2025

(54) AEROSOL GENERATION APPARATUS AND CONTROL METHOD

(71) Applicant: SHENZHEN FIRST UNION TECHNOLOGY CO., LTD., Shenzhen, Guangdong Province (CN)

(72) Inventors: Shengjie HU, Shenzhen, Guangdong Province (CN); Hanliang CHEN, Shenzhen, Guangdong Province (CN); Zhongli XU, Shenzhen, Guangdong Province (CN); Yonghai LI, Shenzhen, Guangdong Province (CN)

(73) Assignee: SHENZHEN FIRST UNION TECHNOLOGY CO., LTD., Shenzhen, Guangdong Province (CN)

(21) Appl. No.: 18/710,457

(22) PCT Filed: Nov. 18, 2022
(86) PCT No.: PCT/CN2022/133000

§ 371 Date: May 15, 2024

(30) Foreign Application Priority Data
Nov. 19, 2021 (CN) 202111376087.9

(51) Int. Cl. A24F 40/57; A24F 40/20; A24F 40/465

(52) U.S. Cl. CPC A24F 40/57; A24F 40/20; A24F 40/465

(57) ABSTRACT

An aerosol generation apparatus and a control method are provided, where the aerosol generation apparatus is configured to receive an aerosol generation product and heat the aerosol generation product to generate an aerosol for inhalation, and the aerosol generation apparatus includes: a heater, configured to heat the aerosol generation product; a battery core, configured to supply power; and a controller, configured to control, when the aerosol generation apparatus operates, power provided from the battery core to the heater, to cause an actual temperature of the heater to meet a preset temperature. The controller is further configured to obtain a change of the power and/or a voltage and/or a current provided from the battery core to the heater, determine a removal event of the aerosol generation product from the aerosol generation apparatus, and stop providing the power to the heater based on the removal event. The aerosol generation apparatus can monitor the removal of the aerosol generation product from the aerosol generation apparatus in a heating process and prevent dry heating after the removal.

### CROSS-REFERENCE TO RELATED APPLICATIONS

This application claims priority to Chinese Patent Application No. 202111376087.9, filed with the China National Intellectual Property Administration on Nov. 19, 2021 and entitled “AEROSOL GENERATION APPARATUS AND CONTROL METHOD”, which is incorporated herein by reference in its entirety.

### TECHNICAL FIELD

Embodiments of this application relate to the technical field of heat-not-burn cigarette apparatuses, and in particular, to an aerosol generation apparatus and a control method.

### BACKGROUND

Tobacco products (such as cigarettes and cigars) burn tobacco during use to produce tobacco smoke. Attempts are made to replace these tobacco-burning products by making products that release compounds without burning.

An example of this type of products is a heating apparatus that releases compounds by heating rather than burning materials. For example, the materials may be tobacco or other non-tobacco products. These non-tobacco products may include or not include nicotine. A heating process of tobacco products by a known heating apparatus is carried out through a temperature curve with a predetermined time set in a controller. During use, before the heating for the predetermined time is completed, the tobacco products may be removed from the heating apparatus due to a user's operation, causing dry heating of the heating apparatus without the tobacco products.

### SUMMARY

An embodiment of this application provides an aerosol generation apparatus, configured to receive an aerosol generation product and heat the aerosol generation product to generate an aerosol for inhalation, where the apparatus includes:
a heater, configured to heat the aerosol generation product;
a battery core, configured to supply power; and
a controller, configured to control power provided from the battery core to the heater, to cause an actual temperature of the heater to meet a preset temperature, where the controller is further configured to monitor the power provided from the battery core to the heater and determine that the aerosol generation product is removed from the aerosol generation apparatus.

Another embodiment of this application further provides a control method for an aerosol generation apparatus, where the aerosol generation apparatus is configured to receive an aerosol generation product and heat the aerosol generation product to generate an aerosol for inhalation, and the aerosol generation apparatus includes:
a heater, configured to heat the aerosol generation product; and
a battery core, configured to supply power, where the method includes:
outputting power to the heater, to cause an actual temperature of the heater to meet a preset temperature;
obtaining a real-time value of an electrical characteristic parameter of the heater;
determining a removal event of the aerosol generation product from the aerosol generation apparatus based on the real-time value of the electrical characteristic parameter; and
stopping outputting power to the heater based on the removal event.

The aerosol generation apparatus can monitor the removal of the aerosol generation product from the aerosol generation apparatus in a heating process and prevent dry heating after the removal.

### BRIEF DESCRIPTION OF THE DRAWINGS

One or more embodiments are exemplarily described with reference to the corresponding figures in the accompanying drawings, and the descriptions do not constitute a limitation to the embodiments. Components in the accompanying drawings that have same reference numerals are represented as similar components, and unless otherwise particularly stated, the figures in the accompanying drawings are not drawn to scale.

FIG. 1 is a schematic diagram of an aerosol generation apparatus according to an embodiment;

FIG. 2 is a schematic diagram of a heating curve of an aerosol generation apparatus in a predetermined time according to an embodiment;

FIG. 3 shows a curve of an effective voltage outputted by a battery core during heating when an aerosol generation apparatus receives and does not receive an aerosol generation product according to an embodiment;

FIG. 4 shows a curve of an effective voltage outputted by a battery core when an aerosol generation product is removed from an aerosol generation apparatus before a predetermined time according to an embodiment; and

FIG. 5 is a schematic diagram of a control method for an aerosol generation apparatus according to an embodiment.

### DETAILED DESCRIPTION

For ease of understanding of this application, this application is described below in more detail with reference to the accompanying drawings and specific implementations.

An embodiment of this application provides an aerosol generation apparatus. Referring to FIG. 1A, a construction of the apparatus may include:
a chamber, where an aerosol generation product A is removably received in the chamber; and
a heater 30, at least partially extending in the chamber, to heat the aerosol generation product A such as a cigarette, so that at least one component of the aerosol generation product A is volatilized, to form an aerosol for inhalation.

In some embodiments, the heater 30 may be a resistive heater 30, or may be an electromagnetic induction heater 30 that generates heat when penetrated by a varying magnetic field.

FIG. 1 is a schematic diagram of an aerosol generation apparatus of the electromagnetic induction heater 30. The apparatus specifically further includes:
a magnetic field generator such as an induction coil 50, configured to generate a varying magnetic field in an alternating current, where the heater 30 is configured to inductively couple to the induction coil 50 to generate heat when penetrated by the varying magnetic field;
a battery core 10, where the battery core 10 is a rechargeable direct current battery core that can output a direct current; and
a circuit 20, where the circuit 20 is connected to the rechargeable battery core 10 through a proper current, and is configured to convert the direct current outputted by the battery core 10 to an alternating current having a proper frequency and supply the alternating current to the induction coil 50.

Further, in an optional embodiment, the aerosol generation product A is preferably a tobacco-containing material that releases volatile compounds from a substrate when heated, or a non-tobacco material suitable for electric heating for smoking after heated. The aerosol generation product A is preferably a solid substrate, where the solid substrate may include one or more powders, granules, fragments, strips or flakes of one or more of vanilla leaves, tobacco leaves, homogenized tobacco, and expanded tobacco, or the solid substrate may contain additional tobacco or non-tobacco volatile flavor compounds to be released when the substrate is heated.

Based on settings used in a product, the induction coil 50 may include an inductor coil wound into a solenoidal tube, as shown in FIG. 1. The induction coil 50 wound into the solenoidal tube may have a radius r in a range of approximately 5 mm to approximately 10 mm, and the radius r may be approximately 7 mm particularly. A length of the cylindrical induction coil 50 wound into the solenoidal tube may be in a range of approximately 8 mm to approximately 14 mm, and the number of turns of the induction coil 50 is in a range of approximately 8 to 15. Correspondingly, an internal volume may be in a range of approximately 0.15 cm³ to approximately 1.10 cm³.

In a more preferred embodiment, a frequency of the alternating current supplied by the circuit 20 to the induction coil 50 is in a range of 80 KHz to 500 KHz. More specifically, the frequency may be in a range of approximately 200 KHz to 300 KHz.

In a preferred embodiment, a direct current supply voltage provided by the battery core 10 is in a range of approximately 2.5 V to approximately 9.0 V, and an amperage of the direct current that the battery core 10 can provide is in a range of approximately 2.5 A to approximately 20 A.

In a preferred embodiment, the heater 30 is substantially in a shape of a pin, a needle, a rod, or a blade, which is conducive to insertion into the aerosol generation product A. In addition, the heater 30 may have a length of approximately 12 mm, a width of approximately 4 mm, and a thickness of approximately 0.5 mm, and may be made of stainless steel 430 (SS430). In an alternative embodiment, the heater 30 may have a length of approximately 12 mm, a width of approximately 5 mm, and a thickness of approximately 0.5 mm, and may be made of stainless steel 430 (SS430). In other variant embodiments, the heater 30 may also be constructed into a cylindrical or tubular shape; and an internal space of the heater 30 during use forms a chamber for receiving the aerosol generation product, and generates an aerosol for inhalation in a manner of heating an outer periphery of the aerosol generation product A. The heater 30 may also be made of stainless steel 420 (SS420) and alloy materials containing iron/nickel (such as permalloy).

In the embodiment shown in FIG. 1, the aerosol generation apparatus further includes a holder 40 configured to arrange the induction coil 50 and the heater 30, and a material of the holder 40 may include a high-temperature-resistant non-metal material with such as PEEK or ceramic. During implementation, the induction coil 50 is wound on an outer wall of the holder 40 to be fixed. In addition, as shown in FIG. 1, the holder 40 is in a hollow tubular shape, and a portion of the hollow tubular space forms the chamber for receiving the aerosol generation product A.

In an optional embodiment, the heater 30 is made of the foregoing sensitive materials; or the heater 30 is obtained by plating or depositing a coating of a sensitive material on the outer surface of a heat-resistant substrate material such as a non-sensitive ceramic.

In an embodiment, the induction coil 50 is made of a low resistivity metal or alloy material, such as gold, silver, copper or alloys thereof. In some preferred embodiments, a wire material of the induction coil 50 is made of a Litz wire or a Litz cable. In a Litz material, the wire or the cable is made of a plurality of or a plurality of bundles of wires, for example, individual isolated wires bundled in a winding or in a braiding manner. The Litz material is particularly suitable for carrying an alternating current. The individual wires are designed to reduce surface effect and near field effect losses in a conductor at a high frequency and allow an interior of the wire material of the induction coil 50 to contribute to conductivity of the induction coil 50.

In some embodiments, the circuit 20 may include a controller. The controller may include a microprocessor, and the microprocessor may be a programmable microprocessor. The controller may include another electronic component. The controller may be configured to regulate power supplied to the induction coil 50, so that the induction coil 50 generates a varying magnetic field.

In some embodiments, the varying magnetic field generated by the induction coil 50 may be supplied to the heater 30 continuously after the apparatus is activated, or may be supplied intermittently, such as on a puff-by-puff basis. The varying magnetic field is supplied to the heater 30 in a form of pulses.

In some embodiments, the power supplied to the induction coil 50 may be triggered by an inhalation detection system. Alternatively, the power supplied to the induction coil 50 may be triggered by pressing an on/off button for inhalation duration of the user. The inhalation detection system may be provided as a sensor, and may be configured as an airflow sensor that may measure an airflow rate. The airflow rate is a parameter that characterizes an amount of air the user inhales each time through an airflow path of the aerosol generation apparatus. The airflow sensor may detect a start of the inhalation when the airflow exceeds a predetermined threshold. The start may also be detected when the user activates the button. The sensor may also be configured as a pressure sensor, to measure pressure of air in the aerosol generation apparatus, and the air is inhaled by the user through the airflow path of the apparatus in an inhalation period.

In some embodiments, the aerosol generation product A is heated by the heater 30 of the aerosol generation apparatus based on a given heating curve. In addition, in a heating process, the circuit 20 controls output power of the battery core 10, to further control an actual temperature of the heater 30 to keep consistent with a preset temperature of the heating curve, or to be in a change interval of the preset temperature. Specifically, the heating curve is in a predetermined time, and the predetermined time is set based on an amount of the aerosol that can be generated by the aerosol generation product A, and inhalation duration that the user is expected to accept (for example, 4 minutes).

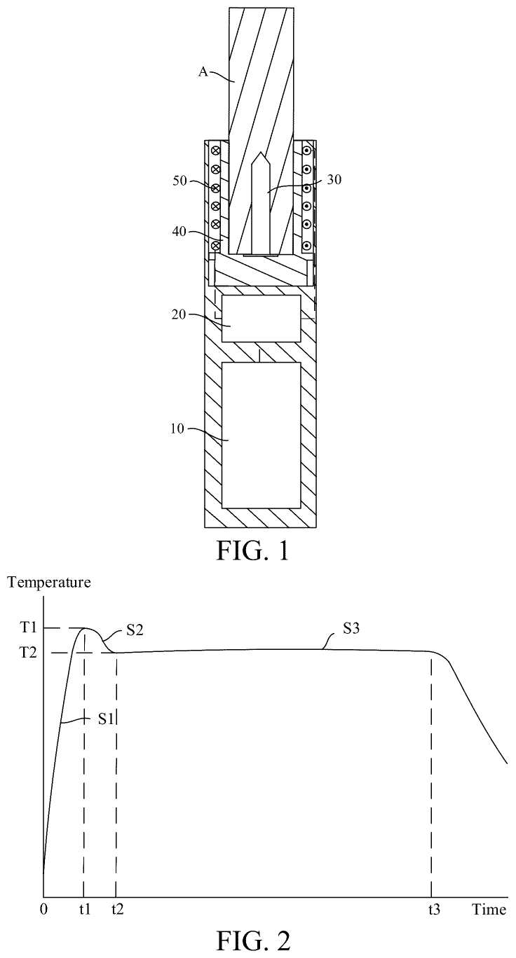

For example, FIG. 2 is a schematic diagram of a typical heating curve of an aerosol generation product A being heated according to a specific embodiment. Based on the heating curve, the heating process includes:

Preheating stage S1: A room temperature is heated rapidly to a first preset temperature T1 within time t1 for preheating;

Cooling stage S2: The first preset temperature T1 is reduced to a second preset temperature T2 within time t2;

Inhalation stage S3: A heating temperature is substantially maintained at the second preset temperature T2 until the end of time t3, so that the aerosol generation product A is heated at the second preset temperature T2 to generate the aerosol for inhalation; and after the inhalation is completed, the power supplied to heater 30 is stopped to cool the heater 30 naturally.

In other variant embodiments, the heating curve may have more temperature variations or more temperature up and down stages.

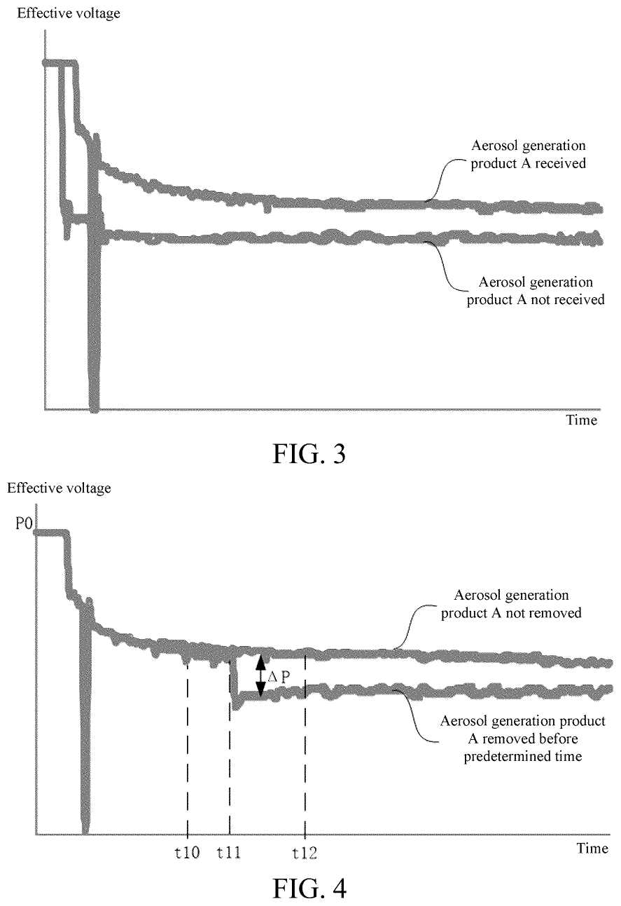

Further, FIG. 3 shows a curve of an effective voltage outputted by a battery core during heating when an aerosol generation apparatus receives and does not receive an aerosol generation product according to an embodiment. As shown in FIG. 3, when the aerosol generation apparatus receives the aerosol generation product A and controls the heater 30 to heat based on the given heating curve, because the generated heat is substantially accepted by the aerosol generation product A and a temperature drop caused by the inhalation of the user needs to be compensated in the heating process, the effective voltage of heating with the aerosol generation product A is greater than the effective voltage without receiving the aerosol generation product A.

It should be explicitly described that “the aerosol generation apparatus receives the aerosol generation product A” is that the described aerosol generation product A is received in the chamber based on a predetermined length. Correspondingly, “the aerosol generation apparatus does not receive the aerosol generation product A” encompasses that the described aerosol generation product A is not received at all in the chamber of the aerosol generation apparatus, or the described aerosol generation product A is partially received in the chamber but is located in the chamber at a length less than the predetermined length.

Further, FIG. 4 shows a curve of an effective voltage outputted to a heater 30 when an aerosol generation product is removed from an aerosol generation apparatus before a predetermined time according to an embodiment. As shown in FIG. 4, the aerosol generation product A is removed from the aerosol generation apparatus at time t11 before the predetermined time due to a non-standard operation or a wrong operation of the user, and the effective voltage provided by the battery core 10 after time t11 drops significantly compared with a case in which the aerosol generation product A is received, and has a difference AP from the effective voltage required for heating when the aerosol generation product A is received. In addition, in this embodiment, because the preset temperature in the inhalation stage is substantially constant, after the aerosol generation product A is removed from the aerosol generation apparatus at time t11, because there is no drop in the temperature of the heater 30 caused by the inhalation of the user, the effective voltage provided to the heater 30 after the removal is substantially constant.

Similarly, in FIG. 4, a change in the effective voltage value Vᵣₘₛ of the alternating current supplied to the induction coil 50 is sampled to measure a change in the power supplied to the heater 30. Alternatively, in other variant embodiments, for different heating forms, for example, when the direct current is supplied directly to the resistive heater 30 in a PWM (pulse width modulation) or PFM (pulse frequency modulation) control modulation mode, the change in the power supplied to the heater 30 can be measured by monitoring the pulse width or the pulse frequency of the voltage or the current corresponding to the selected control mode. Alternatively, in some other embodiments, the power outputted by the battery core 10 to the heater 30 can be directly monitored, and a change curve in the heating process can determine the power and the power change of whether the aerosol generation product A is removed. A general shape of the power curve is similar to the effective voltage curve in FIG. 3 and FIG. 4.

Based on the foregoing, in an embodiment of this application, the circuit 20 is configured to:
determine, based on the power provided by the battery core 10 to the heater 30, that the aerosol generation product A is removed from the aerosol generation apparatus.

It should be explicitly described that “the removal of the aerosol generation product A from the aerosol generation apparatus” encompasses that the described aerosol generation product A is completely removed from the chamber of the aerosol generation apparatus, or moves outside the chamber by a distance based on the predetermined length received in the chamber, causing the length received in the chamber to be less than the predetermined length.

Further, the circuit 20 is configured to stop/prevent providing power to the heater 30 when it is determined that the aerosol generation product A is removed, to avoid dry heating of the heater 30.

In a specific embodiment, the circuit 20 is configured to determine that the aerosol generation product A is removed when the power provided to the heater 30 is less than or equal to a minimum threshold. For example, as shown in FIG. 4, after the aerosol generation product A is removed, the power curve for heating is set to a minimum threshold, and when the power provided to the heater 30 is less than or equal to the minimum threshold, it is determined that the aerosol generation product A is removed.

In some specific embodiments, a battery core 10 usually using standard single 3.7 V output currently (for example, a battery core of 08570P 3.7 V 280 mAh model) outputs a pulse voltage at a frequency of 200 KHz to 300 KHz to a series LC oscillator formed by a capacitor C and the induction coil 50, causing the LC oscillator to oscillate to generate an alternating current. When the preset temperature of 320 degrees is used as the heating temperature for heating, for the heater 30 made of a 1J85 permalloy material and the aerosol generation product A having a conventional 5.4-mm outer diameter, during heating, when the aerosol generation product A is removed, the effective voltage Vᵣₘₛ applied to the induction coil 50 drops below 1500 mV from approximately 2000 mV at an instant moment (for example, within 1 s), where the effective voltage drops by approximately 500 mV and has a drop of approximately 25%.

Based on the foregoing specific embodiment, a 25% drop in the preset power/effective voltage is set as the preset threshold, and when the 25% preset threshold is exceeded, it may be regarded that the aerosol generation product A is removed. Alternatively, in a more accurate embodiment, a 20% drop in the preset power/effective voltage may further be set as the preset threshold, and determining of the results may be more accurate. Alternatively, more preferably, it is feasible to further set a 15% drop in the preset power/effective voltage as the preset threshold.

Further, in different embodiments, selection of the preset threshold needs to be correspondingly adjusted.

For example, when the heating curve of the aerosol generation apparatus adopts a curve having a preset temperature of 350 degrees, 380 degrees, or a higher temperature, preset power maintained at higher temperatures increases correspondingly. Correspondingly, when the aerosol generation product A is removed, the drop in the power or the effective voltage value at an instant moment of the removal (for example, within 1 s) is low, and it is feasible to further set the 10% drop in the preset power/effective voltage as the preset threshold.

Further, based on the foregoing various electromagnetic, resistive, microwave or infrared heating methods and differences in the specific structure of the circuit 20, technicians can measure the drop in the power caused by the removal of the aerosol generation product A during specific implementation, and it is easy to set the preset threshold properly based on the measured value.

Alternatively, in another variant embodiment, the circuit 20 is configured to determine, based on a difference AP between the power provided to the heater 30 and a preset threshold, that the aerosol generation product A is removed. As shown in FIG. 4, the power curve for heating when the aerosol generation product A is received is used as the preset threshold. When the difference AP (which is a negative value) between the provided power and the preset threshold exceeds a preset magnitude, it indicates that the aerosol generation product A is removed.

Alternatively, in another specific embodiment, the circuit 20 is configured to determine, based on a change amount or a change rate in the power provided to the heater 30 within a preset time, that the aerosol generation product A is removed. For example, in FIG. 4, when a time from time t10 to time t12 is selected as the preset time in the heating process, a change amount or a change rate in the power provided by the aerosol generation product A to the heater 30 when the aerosol generation product A is not removed is less than the change amount or the change rate of the power when the aerosol generation product A is removed. Similarly, the circuit 20 is configured to determine, when the change amount or the change rate of the power provided to the heater 30 is greater than a maximum threshold within the preset time, that the aerosol generation product A is removed.

It should be explicitly described that “the change amount or the change rate of the power provided to the heater 30 within the preset time is greater than the maximum threshold” encompasses a case in which the described change amount or change rate reaches the maximum threshold earlier or faster than a preset time period. In some optional embodiments, the preset time period is, for example, in a range of 50 ms to 200 ms, or may be in a range of 80 ms to 200 ms. Alternatively, in some preferred embodiments, the preset time period is in a range of 50 ms to 150 ms.

A more precise threshold can be set by determining, based on the power provided to heater 30, that the aerosol generation product A is removed. The power provided to the heater 30 does not depend on changes in a size or a shape of the heater 30 due to manufacturing tolerances.

Based on the foregoing manner of electromagnetic induction heating, during implementation, the power provided to the heater 30 may be determined by monitoring an eddy current loss generated in the induction heating of the heater 30.

Further, in some common embodiments, the alternating current provided to the induction coil 50 is formed by an LC oscillator (which may be connected in series or in parallel) formed by a capacitor C and the induction coil 50 in an oscillation process, and the oscillation of the LC oscillator is driven by a voltage pulse provided by the battery core 10. In addition, the power provided to the heater 30 may be determined by monitoring a pulse width and/or a frequency of the voltage pulse provided by the battery core 10, which is easier than by monitoring the eddy current loss.

Further, in a more preferred embodiment, because the power provided to the heater 30 is implemented by the alternating current provided to the induction coil 50 causing the induction coil 50 to generate a varying magnetic field, the power provided to the heater 30 may be determined by monitoring the effective voltage value Vᵣₘₛ of the alternating current supplied to the induction coil 50, which is easier than by monitoring the eddy current loss. Alternatively, in some other variant embodiments, the circuit 20 determines the power provided to the heater 30 based on the effective current of the alternating current supplied to the induction coil 50.

Alternatively, in some other variant embodiments, a load of the battery core 10 is formed by the circuit 20, the induction coil 50, and the heater 30 jointly. During implementation, losses of the circuit 20 and the induction coil 50 in the load are substantially rated or known. Further, the power provided to the heater 30 can be calculated by monitoring electrical characteristic parameters such as the voltage and/or the current outputted by the battery core 10 to the load.

In some other variant embodiments, the heater 30 used in the aerosol generation apparatus is a resistive heater. Correspondingly, in the heating process, the heater 30 generates joule heat to generate heat by providing a direct current to the heater 30 through the battery core 10. Correspondingly, during implementation, the power provided to the heater 30 is calculated by monitoring the electrical characteristic parameters such as the power supply voltage U and the current I directly outputted to the heater 30 by the battery core 10 and in combination with a resistance value R of the heater 30. For example, the power provided to the heater 30 is determined through a power calculation formula P=U²/R, P=I²R, P=UI, or the like.

Alternatively, in some other embodiments, a given or preset power curve or temperature curve is modified or adjusted based on the detected power provided to the heater 30, and the power provided to the heater 30 is controlled based on the changed power curve or temperature curve.

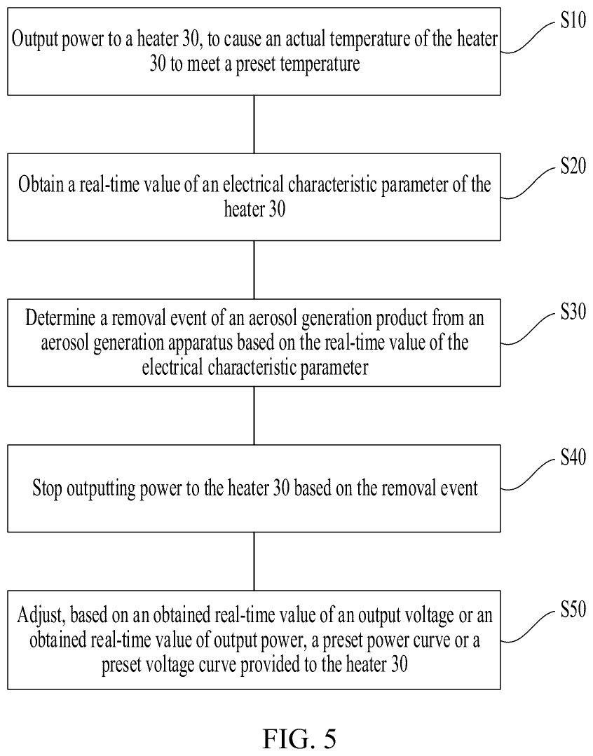

Another embodiment of this application provides a control method for an aerosol generation apparatus. Referring to FIG. 5, the method may, include the following steps:
S10. Output power to a heater 30, to cause an actual temperature of the heater 30 to meet a preset temperature.
S20. Obtain a real-time value of an electrical characteristic parameter of the heater 30.
S30. Determine a removal event of an aerosol generation product from the aerosol generation apparatus based on the real-time value of the electrical characteristic parameter.
S40. Stop outputting power to the heater 30 based on the removal event.

In some other embodiments, the electrical characteristic parameter includes an output voltage or output power, and the determining a removal event of the aerosol generation product from the aerosol generation apparatus based on the real-time value of the electrical characteristic parameter includes:
determining, based on a real-time value of the output voltage and a preset voltage curve, that a drop occurs in the real-time value of the output voltage in a preset time period relative to a corresponding value in the preset voltage curve, and determining the removal event of the aerosol generation product from the aerosol generation apparatus; or
determining, based on a real-time value of the output power and a preset power curve, that a drop occurs in the real-time value of the output power in a preset time period relative to a corresponding value in the preset power curve, and determining the removal event of the aerosol generation product from the aerosol generation apparatus.

For example, during implementation, the electrical characteristic parameters may be the effective voltage or the power in FIG. 4. In addition, the effective voltage curve or the power curve for heating when the aerosol generation product A in FIG. 4 is not removed is set as a preset voltage curve or a preset power curve, and the like. Then, during implementation, an actual voltage or actual power of the actual heating monitored in real time is compared with a corresponding value in the preset voltage curve or the preset power curve, and the removal event is determined when there is a drop similar to that in FIG. 4 by comparing with the corresponding value.

In some other embodiments, the electrical characteristic parameter includes an output voltage or output power, and the determining a removal event of the aerosol generation product from the aerosol generation apparatus based on the real-time value of the electrical characteristic parameter includes:
determining, based on a real-time value of the output voltage and a preset voltage curve, that a drop occurs in the real-time value of the output voltage in a preset time period relative to a corresponding value in the preset voltage curve, where the drop magnitude meets a preset magnitude value, and determining the removal event of the aerosol generation product from the aerosol generation apparatus; or
determining, based on a real-time value of the output power and a preset power curve, that a drop occurs in the real-time value of the output power in a preset time period relative to a corresponding value in the preset power curve, where the drop magnitude meets a preset magnitude value; and determining the removal event of the aerosol generation product from the aerosol generation apparatus.

Similarly, during implementation, the effective voltage curve or the power curve for heating when the aerosol generation product A in FIG. 4 is not removed is set as a preset voltage curve or a preset power curve, and the like. Then, during implementation, an actual voltage or actual power of the actual heating monitored in real time is compared with a corresponding value in the preset voltage curve or the preset power curve, and the removal event is determined when there is a preset drop similar to that in the power or voltage described above.

In some other embodiments, the electrical characteristic parameter includes an output voltage or output power, and the determining a removal event of the aerosol generation product from the aerosol generation apparatus based on the real-time value of the electrical characteristic parameter includes:
determining, based on a real-time value of the output voltage and a preset voltage threshold, that the real-time value of the output voltage in a preset time period is less than the preset voltage threshold, and determining the removal event of the aerosol generation product from the aerosol generation apparatus; or
determining, based on a real-time value of the output power and a preset power threshold, that the real-time value of the output power is less than the preset power threshold in a preset time period, and determining the removal event of the aerosol generation product from the aerosol generation apparatus.

Similarly, during implementation, the effective voltage curve or the power curve for heating when the aerosol generation product A in FIG. 4 is not removed is set as a preset voltage curve or a preset power curve, and the like. Further, a preset time period, for example, the time from time t10 to time t12 in FIG. 4, is selected, the real-time value of the voltage or the power outputted by the battery core 10 is monitored in the time period, and the real-time value of the voltage or the power is compared with a corresponding value of the preset voltage curve or the preset power curve. The removal event is determined when the real-time value of the output voltage or the power within the preset time is less than the corresponding value of the preset voltage curve or the preset power curve.

In some other embodiments, the preset time period is greater than duration of a cooling stage of the aerosol generation apparatus.

In some other embodiments, the electrical characteristic parameter includes an output voltage or output power, and the method further includes:
S50. Adjust, based on an obtained real-time value of the output voltage or an obtained real-time value of the output power, the preset power curve or the preset voltage curve provided to the heater 30. During implementation, a given or preset power curve or temperature curve is modified or adjusted, and the power provided to the heater 30 is controlled based on the changed power curve or temperature curve. In this way, the curve can be more closely fitted to the actual heating situation of the apparatus, and can be used to more accurately determine whether dry heating occurs, to prevent the dry heating.

It should be noted that, the specification of this application and the accompanying drawings thereof illustrate preferred embodiments of this application, but this application is not limited to the embodiments described in the specification. Further, a person of ordinary skill in the art may make improvements or variations according to the foregoing descriptions, and such improvements and variations shall all fall within the protection scope of the appended claims of this application.

1. An aerosol generation apparatus, configured to receive an aerosol generation product and heat the aerosol generation product to generate an aerosol for inhalation, wherein the apparatus comprises:
a heater, configured to heat the aerosol generation product;
a battery core, configured to supply power; and
a controller, configured to control, when the aerosol generation apparatus operates, power provided from the battery core to the heater, to cause an actual temperature of the heater to meet a preset temperature, wherein
the controller is further configured to: obtain a change in at least one parameter of the power, a voltage, and a current provided from the battery core to the heater; determine a removal event of the aerosol generation product from the aerosol generation apparatus based on the change of the parameter; and control, based on the removal event, the battery core to stop providing the power to the heater.

2. The aerosol generation apparatus according to claim 1, wherein the controller is configured to determine the removal event of the aerosol generation product from the aerosol generation apparatus when the at least one parameter of the power, the voltage, and the current provided from the battery core to the heater drops below a preset threshold.

3. The aerosol generation apparatus according to claim 1, wherein the controller is configured to determine the removal event of the aerosol generation product from the aerosol generation apparatus based on a difference between the at least one parameter of the power, the voltage, and the current provided from the battery core to the heater and a preset threshold.

4. The aerosol generation apparatus according to claim 1, wherein the controller is configured to determine the removal event of the aerosol generation product from the aerosol generation apparatus based on a change amount or a change rate of the at least one parameter of the power, the voltage, and the current provided from the battery core to the heater within a preset time.

5. The aerosol generation apparatus according to claim 1, wherein the aerosol generation apparatus further comprises:
an induction coil, wherein the controller is configured to guide an alternating current to flow through the induction coil, to cause the induction coil to generate a varying magnetic field; and
the heater is an electromagnetic induction heater penetrated by the varying magnetic field to generate heat.

6. The aerosol generation apparatus according to claim 5, wherein the controller is configured to obtain, based on an eddy current loss generated by the heater in the varying magnetic field, the at least one parameter of the power, the voltage, and the current provided from the battery core to the heater.

7. The aerosol generation apparatus according to claim 5, wherein the controller is configured to obtain, based on an effective voltage value of the alternating current flowing through the induction coil, the at least one parameter of the power, the voltage, and the current provided from the battery core to the heater.

8. A control method for an aerosol generation apparatus, wherein the aerosol generation apparatus is configured to receive an aerosol generation product and heat the aerosol generation product to generate an aerosol for inhalation; the aerosol generation apparatus comprises a heater configured to heat the aerosol generation product and a battery core configured to supply power; and the method comprises:
outputting power to the heater, to cause an actual temperature of the heater to meet a preset temperature;
obtaining a real-time value of an electrical characteristic parameter of the heater;
determining a removal event of the aerosol generation product from the aerosol generation apparatus based on the real-time value of the electrical characteristic parameter; and
stopping outputting power to the heater based on the removal event.

9. The control method for an aerosol generation apparatus according to claim 8, wherein the electrical characteristic parameter comprises an output voltage or output power, and the determining a removal event of the aerosol generation product from the aerosol generation apparatus based on the real-time value of the electrical characteristic parameter comprises:
determining, based on a real-time value of the output voltage and a preset voltage curve, that a drop occurs in the real-time value of the output voltage in a preset time period relative to a corresponding value in the preset voltage curve, and determining the removal event of the aerosol generation product from the aerosol generation apparatus; or
determining, based on a real-time value of the output power and a preset power curve, that a drop occurs in the real-time value of the output power in a preset time period relative to a corresponding value in the preset power curve, and determining the removal event of the aerosol generation product from the aerosol generation apparatus.

10. The control method for an aerosol generation apparatus according to claim 8, wherein the electrical characteristic parameter comprises an output voltage or output power, and the determining a removal event of the aerosol generation product from the aerosol generation apparatus based on the real-time value of the electrical characteristic parameter comprises:
determining, based on a real-time value of the output voltage and a preset voltage curve, that a drop occurs in the real-time value of the output voltage in a preset time period relative to a corresponding value in the preset voltage curve, wherein the drop magnitude meets a preset magnitude value, and determining the removal event of the aerosol generation product from the aerosol generation apparatus; or
determining, based on a real-time value of the output power and a preset power curve, that a drop occurs in the real-time value of the output power in a preset time period relative to a corresponding value in the preset power curve, wherein the drop magnitude meets a preset magnitude value, and determining the removal event of the aerosol generation product from the aerosol generation apparatus.

11. The control method for an aerosol generation apparatus according to claim 8, wherein the electrical characteristic parameter comprises an output voltage or output power, and the determining a removal event of the aerosol generation product from the aerosol generation apparatus based on the real-time value of the electrical characteristic parameter comprises:
determining, based on a real-time value of the output voltage and a preset voltage threshold, that the real-time value of the output voltage in a preset time period is less than the preset voltage threshold, and determining the removal event of the aerosol generation product from the aerosol generation apparatus; or
determining, based on a real-time value of the output power and a preset power threshold, that the real-time value of the output power is less than the preset power threshold in a preset time period, and determining the removal event of the aerosol generation product from the aerosol generation apparatus.

12. The control method for an aerosol generation apparatus according to claim 9, wherein
the preset time period is greater than duration of a cooling phase of the aerosol generation apparatus.

13. The control method for an aerosol generation apparatus according to claim 9, wherein the electrical characteristic parameter comprises an output voltage or output power, and the method further comprises:
adjusting, based on an obtained real-time value of the output voltage or an obtained real-time value of the output power, the preset power curve or the preset voltage curve provided to the heater.

14. The aerosol generation apparatus according to claim 2, wherein the aerosol generation apparatus further comprises:
an induction coil, wherein the controller is configured to guide an alternating current to flow through the induction coil, to cause the induction coil to generate a varying magnetic field; and
the heater is an electromagnetic induction heater penetrated by the varying magnetic field to generate heat.

15. The aerosol generation apparatus according to claim 3, wherein the aerosol generation apparatus further comprises:
an induction coil, wherein the controller is configured to guide an alternating current to flow through the induction coil, to cause the induction coil to generate a varying magnetic field; and
the heater is an electromagnetic induction heater penetrated by the varying magnetic field to generate heat.

16. The aerosol generation apparatus according to claim 4, wherein the aerosol generation apparatus further comprises:
an induction coil, wherein the controller is configured to guide an alternating current to flow through the induction coil, to cause the induction coil to generate a varying magnetic field; and
the heater is an electromagnetic induction heater penetrated by the varying magnetic field to generate heat.

17. The control method for an aerosol generation apparatus according to claim 10, wherein
the preset time period is greater than duration of a cooling phase of the aerosol generation apparatus.

18. The control method for an aerosol generation apparatus according to claim 11, wherein
the preset time period is greater than duration of a cooling phase of the aerosol generation apparatus.
